(19) United States
(12) Patent Application Publication
(10) Pub. No.: US 2008/0242396 A1
(43) Pub. Date: Oct. 2, 2008

(54) GAMING MACHINE CAPABLE OF PERFORMING MINI GAME AND PLAYING METHOD THEREOF

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/020,703

(22) Filed: Jan. 28, 2008

Related U.S. Application Data
(60) Provisional application No. 60/907,268, filed on Mar. 27, 2007.

(51) Int. Cl. A63F 13/00

(52) U.S. Cl. 463/20

(57) ABSTRACT

A gaming machine according to the present invention comprising: a display capable of rearranging a plurality of symbols thereto; an input device with which a player is capable of performing an operation relating to a game; and a controller, the controller programmed to conduct the processing of; (a) executing a game in which the plurality of symbols are rearranged to the display and a gaming medium is paid out in number corresponding to the symbols rearranged or a combination thereof; (b) displaying, in a time period during which at least a single game is executed, a predetermined number of cards for use in a mini game which is different from the game, to the display; (c) determining cards for use in the mini game or a combination thereof, based on an input from the input device, in the game after the processing (b); (d) determining, in the game after the processing (c), a result of the mini game based on the cards displayed in the processing (b) and the result of the determination in the processing (c), and offering a point value to the player based on this result; and (e) executing a bonus game by consuming the point value, out of a normal game to be executed as the game and the bonus game which is more advantageous to the player than the normal game.

### CROSS-REFERENCE TO RELATED APPLICATIONS

This application claims benefit of priority based on U.S. Provisional Patent Application No. 60/907,268 filed on Mar. 27, 2007. The contents of this application are incorporated herein by reference in their entirety.

### BACKGROUND OF THE INVENTION

### FIELD OF THE INVENTION

The present invention relates to a gaming machine capable of executing a mini game.

### DISCUSSION OF THE BACKGROUND

Conventionally, there has been a slot machine which executes a free game in the case of the establishment of a predetermined condition (for example, a specific symbol should be stop-displayed in a slot machine game) during a game. The free game is a game which can be executed without consuming a gaming medium. For example, as disclosed in AU 1972901-A, there is a slot machine which executes a free game as a sub game, in the case of the establishment of the predetermined condition (symbols should be arranged in a specific manner) during a basic game.

Further, in recent years, there has been a gaming machine which executes a mini game for a player to acquire a point value during a specific game which is more advantageous to the player than a normal game, and allows the player to use the point value acquired in the mini game, in a bonus game (for example, a free game) executed thereafter.

It is an object of the present invention to provide a gaming machine capable of executing a mini game, thereby offering new entertainment.

The contents of AU 1972901-A is incorporated herein by reference in their entirety.

### SUMMARY OF THE INVENTION

According to the present invention, there is provided a gaming machine having the following structure.

Namely, the above-mentioned gaming machine comprises a display capable of rearranging a plurality of symbols thereto; an input device with which a player is capable of performing an operation relating to a game; and a controller. The controller is programmed to conduct the processing of; (a) executing a game in which the plurality of symbols are rearranged in the display and a gaming medium is paid out in number corresponding to the symbols rearranged or a combination thereof; (b) displaying, in a time period during which at least a single game is executed, a predetermined number of cards for use in a mini game which is different from the game, to the display; (c) determining cards for use in the mini game or a combination thereof, based on an input from the input device, in the game after the processing (b); (d) determining, in the game after the processing (c), a result of the mini game based on the cards displayed in the processing (b) and the result of the determination in the processing (c), and offering a point value to the player based on this result; and (e) executing a bonus game by consuming the point value, out of a normal game to be executed as the game and the bonus game which is more advantageous to the player than the normal game.

Further, it is preferable that the gaming machine according to the present invention have the following structure.

The processing (b) is a processing of gradually adding cards to be displayed to the display, successively or intermittently during the plurality of games, until the number of cards displayed to the display reaches a predetermined number.

Further, it is preferable that the gaming machine according to the present invention have the following structure.

The symbols indicate cards for use in the mini game, and the processing (b) is a processing of selecting the symbol included in the plurality of symbols rearranged in the game and displaying the card indicated by the selected symbol to the display, successively or intermittently during the plurality of games, until the number of cards displayed to the display reaches a predetermined number.

Further, it is preferable that the gaming machine according to the present invention have the following structure.

The processing (c) is a processing of dividing the predetermined number of cards into a plurality of sets of cards to form a plurality of combinations of player's cards, based on the input from the input device, in the game after the processing (b); and the processing (d) is a processing of determining the same number of cards as the number of cards displayed in the processing (b) and dividing the determined cards into a plurality of sets of cards to form a plurality of combinations of banker's cards, the plurality of combinations of banker's cards are same as the combinations of player's cards in the number of sets and the numbers of cards in the respective sets, and comparing the plurality of combinations of player's cards with the plurality of combinations of banker's cards based on the strength of hands to determine the result of the mini game, and offering a point value to the player based on this result.

Further, it is preferable that the gaming machine according to the present invention have the following structure.

The processing (c) is a processing of dividing the predetermined number of cards into a plurality of sets of cards, based on a predetermined rule, to form a plurality of combinations of player's cards, when there is no input from the input device for a predetermined time period since the number of the player's cards displayed to the display has reached the predetermined number.

According to the present invention, there is provided a game controlling method having the following structure.

Namely, the game controlling method comprises the steps of: (a) executing a game in which a plurality of symbols are rearranged in a display and a gaming medium is paid out in number corresponding to the symbols rearranged or a combination thereof; (b) displaying, in a time period during which at least a single game is executed, a predetermined number of cards for use in a mini game which is different from the game, to the display; (c) determining cards for use in the mini game or a combination thereof, based on an input from an input device, in the game after the step (b); (d) determining, in the game after the step (c), a result of the mini game based on the cards displayed in the step (b) and the result of the determination in the step (c), and offering a point value to the player based on this result; and (e) executing a bonus game by consuming the point value, out of a normal game to be executed as the game and the bonus game which is more advantageous to the player than the normal game.

### BRIEF DESCRIPTION OF THE DRAWINGS

FIG. 1A is a view illustrating an exemplary image which is displayed to a lower image display panel included in a slot machine according to one embodiment of the present invention.

FIG. 1B is another view illustrating an exemplary image which is displayed to the lower image display panel included in the slot machine according to the embodiment of the present invention.

FIG. 1C is another view illustrating an exemplary image which is displayed to the lower image display panel included in the slot machine according to the embodiment of the present invention.

FIG. 2 is a view illustrating a correspondence between a player's high hand and a point value.

FIG. 3A is a view illustrating an exemplary symbol matrix;

FIG. 3B is another view illustrating an exemplary symbol matrix;

FIG. 3C is another view illustrating an exemplary symbol matrix;

FIG. 4 is a perspective view schematically illustrating a slot machine according to one embodiment of the present invention;

FIG. 5 is a block diagram illustrating an internal structure of the slot machine illustrated in FIG. 4;

FIG. 6A is a flow chart illustrating a subroutine of slot game execution processing;

FIG. 6B is another flow chart illustrating a subroutine of slot game execution processing;

FIG. 7 is a flow chart illustrating a subroutine of symbol rearrangement processing; and

FIG. 8 is a flow chart illustrating a subroutine of a bonus game execution processing.

### DESCRIPTION OF THE EMBODIMENTS

On a slot machine 10 according to an embodiment of the present invention, two types of games are executed. Namely, on the slot machine according to the present embodiment, a slot machine game is executed as a main game and Pai-Gow poker is executed as a mini game. The slot machine 10 corresponds to a gaming machine according to the present invention. Further, the slot machine 10 is a standalone type slot machine that is not connected to a network, but it is possible to apply the present invention to a slot machine connected to a network.

Hereinafter, first, there will be described Pai-Gow poker which is executed as the mini game.

First, there will be described a rule of Pai-Gow poker.

In Pai-Gow poker, a player and a banker play a game against each other, using playing cards. More specifically, seven cards are dealt to each of the player and the banker. The player and the banker divide their seven cards into a set of five cards and a set of two cards. At this time, the hand of five cards (a high hand) must be as strong as the hand of two cards (a low hand) or stronger than the hand of two cards. Next, by comparing the player's hand of five cards with the banker's hand of five cards, which of them is stronger than the other is determined. Similarly, by comparing the player's hand of two cards with the banker's hand of two cards, which of them is stronger than the other is determined. When both the banker's hands of five cards and the two cards are stronger than those of the player's, the game results in winning of the banker. When both the player's hands of five cards and two cards are stronger than those of the banker's, the game results in winning of the player. When one player's hand, out of the hands of five cards and two cards, is stronger than the banker's corresponding hand and the other banker's hand is stronger than the player's corresponding hand, the game results in a draw. Further, when both the player's hands of five cards and two cards are as strong as those of the banker's, the game results in winning of the banker. Further, as hands of five cards, there are Royal Flush, Straight Flush, Four of a kind, Full House, Flush, Straight, Three of a kind, Two Pair, One Pair, and No Pair, in the order of strength. As hands of two cards, there are One Pair and No Pair, in the order of strength.

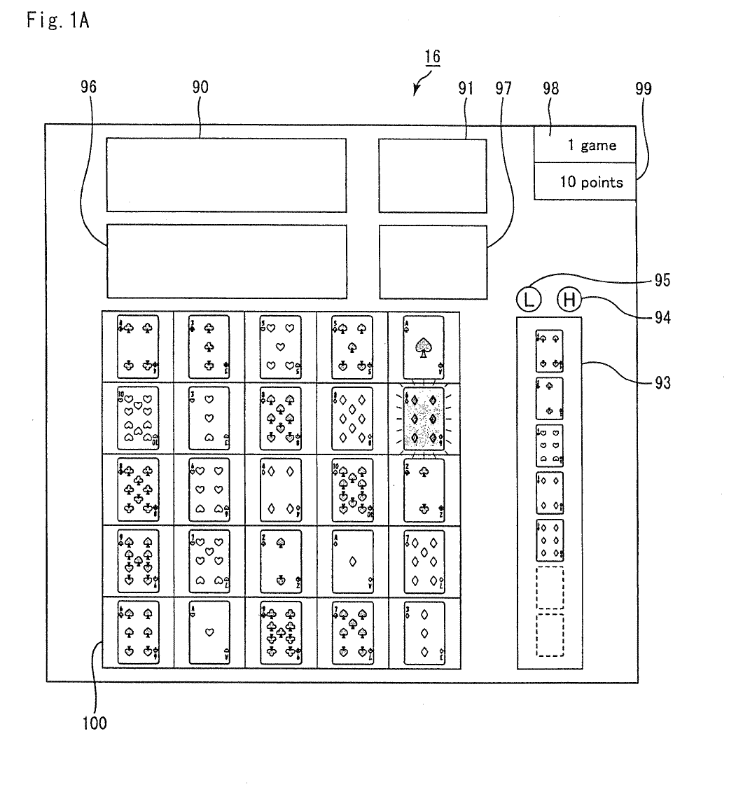

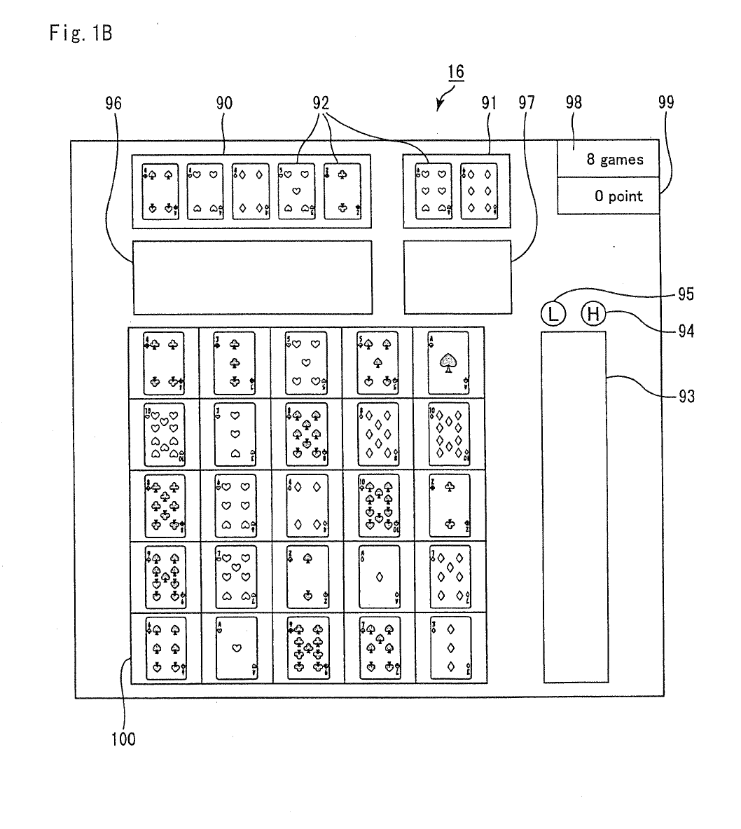

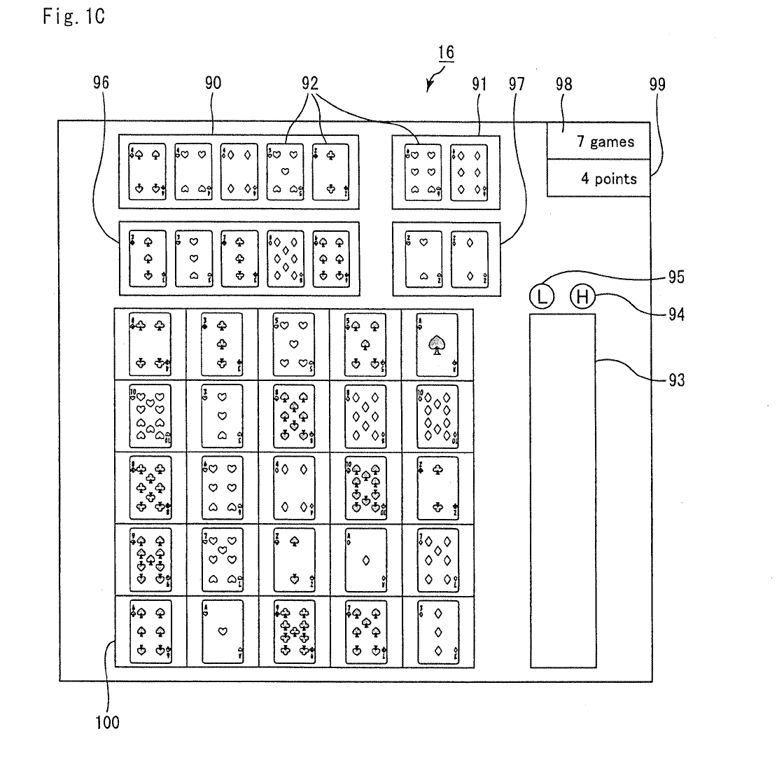

Subsequently, with reference to FIGS. 1A, 1B, and 1C, there will be described the mini game which is executed in the present embodiment.

FIGS. 1A, 1B, and 1C are views respectively illustrating exemplary images which are displayed to a lower image display panel included in the slot machine according to an embodiment of the present invention.

The slot machine 10 according to the present embodiment comprises the lower image display panel 16 and at the front face of the lower image display panel 16, a touch panel 69 is provided. The lower image display panel 16 corresponds to a display according to the present invention, and the touch panel 69 corresponds to an input device according to the present invention.

In the present embodiment, a Pai-Gow poker game which is executed as the mini game is comprised of three stages. The first stage is a stage in which player's seven cards to be used in Pai-Gow poker are displayed to the lower image display panel 16. The second stage is a stage in which the player's seven cards displayed to the lower image display panel 16 are divided into two sets of cards (a set of five cards and a set of two cards). The third stage is a stage in which a result of the game is determined by comparing the player's hands with the banker's hands, and a point value is offered based on this result. The point value is a numerical value to be used in a bonus game. In the bonus game, a free game is executed. The free game is executed regarding that the coins in the same number at the time of generation of the free game have been inserted, even though no coins have been inserted.

In the present embodiment, when the combination of symbols rearranged in the slot machine game is a predetermined combination, 10 free games are executed as the bonus game. When the player has the point value, the player can consume this point value to continue playing the free game, even after the 10 free games end. The player can acquire the point value through the mini game and play the bonus game by using the acquired point value.

While, in the present embodiment, the free game is executed as the bonus game, the bonus game according to the present invention is not particularly limited, provided that the bonus game is a game more advantageous than the normal game (a game other than the bonus game, out of the slot machine games). Exemplary bonus games may include a game in which a greater number of coins may be acquired than in the normal game, a game in which a probability to acquire the coin is higher than in the normal game, a game in which a smaller number of coins are consumed than in the normal game, and the like. More specifically, as the bonus game, there are the free game, a second game, a mystery bonus, and the like.

FIG. 1A illustrates an image which is displayed in the first stage. FIG. 1B illustrates an image which is displayed in the second stage. FIG. 1C illustrates an image which is displayed in the third stage. Hereinafter, the three stages will be described, with reference to FIGS. 1A, 1B, and 1C.

First, with reference to FIG. 1A, the first stage will be described.

As illustrated in FIG. 1A, at the right end of the lower image display panel 16, there is provided a mini-game card display section 93. To the mini-game card display section 93, player's cards to be used in Pai-Gow poker which is executed as the mini game, are displayed.

Further, to the left side of the mini-game card display section 93, there is displayed a symbol matrix SM 100. The symbol matrix SM 100 is comprised of a total of 25 symbols in five columns and five rows. As illustrated in FIG. 1A, in the slot machine 10 according to the present embodiment, playing cards are displayed as symbols.

The cards to be displayed to the mini-game card display section 93 are determined based on the symbols rearranged in the symbol matrix SM 100, as following. At first, after symbols are rearranged in the symbol matrix SM 100, a single symbol is determined at random out of the rearranged symbols. Then, a playing card having the same rank and the same suit as those of the playing card displayed as the selected symbol, is displayed to the mini-game card display section 93. FIG. 1A illustrates a state where a symbol indicating a playing card of “Diamond and 6” has been determined out of the rearranged symbols and a playing card of “Diamond and 6” is displayed to the mini-game card display section 93. The number of cards displayed to the mini-game card display section 93 is gradually increased until the number reaches seven, along with the progression of the slot machine game being executed as the main game.

Further, at an upper right portion of the lower image display panel 16, there are provided a number-of-bonus-game display section 98 and a cumulative point value display section 99. The number-of-bonus-game display section 98 displays the number “T” of remaining free games to be executed as the bonus game. On the other hand, the cumulative point value display section 99 displays the value “P” of the point value which has been cumulatively accumulated.

In the example of FIG. 1A, the number-of-bonus-games display section 98 displays “1 game”. Namely, there is illustrated a state where the bonus game will end with the current game, unless the bonus game is continued by using the point value, as will be described with reference to FIG. 1B. Further, on the other hand, the value of “T” displayed to the number-of-bonus-game display section 98 is not zero, and therefore, in FIG. 1A, there is illustrated a state where the mini game is being executed during the bonus game. In the present embodiment, the mini game may be executed during the bonus game, as described above, but also it may be executed during the normal game, as will be described later. In the present invention, a timing of an execution of the mini game is not particularly limited. The timing thereof may be either during the normal game or during the bonus game.

Next, with reference to FIG. 1B, the second stage will be described.

As illustrated in FIG. 1B, at an upper portion of the lower image display panel 16, there are provided a player's-high-hand display section 90 for displaying the player's high hand and a player's-low-hand display section 91 for displaying the player's low hand. The player's-high-hand display section 90 and the player's-low-hand display section 91 display card images 92 indicating the cards of the player's high hand and the player's low hand, respectively. Further, above the mini-game card display section 93, there are provided a high-hand determination button 94 and a low-hand determination button 95 for determining the cards forming the player's high hand and the low hand.

In the game after the number of cards displayed to the mini-game card display section 93 has reached seven, the player divides the cards for the mini game into two sets of cards as below. Namely, the player determines the high hand by selecting cards that he or she desires to have in his or her high hand out of the cards displayed to the mini-game-card display section 93 through the touch panel 69 and operating the high-hand determination button 94 through the touch panel 69. The cards determined to be included in the high hand are displayed to the player's-high-hand display section 90. Similarly, the player determines the low hand by selecting cards that he or she desires to have in his or her low hand out of the cards displayed to the mini-game card display section 93 through the touch panel 69 and operating the low-hand determination button 95 through the touch panel 69. In the example of FIG. 1B, there is illustrated a state where both the high hand and the low hand have been determined, and the five cards forming the high hand are displayed to the player's-high-hand display section 90 and the two cards forming the low hand are displayed to the player's-low-hand display section 91. The five cards forming the high hand and the two cards forming the low hand correspond to combinations of player's cards according to the present invention.

Further, in FIG. 1B compared to FIG. 1A, the number “T” of remaining free games to be executed and the point value “P” have been changed as follows.

T: 1→8

P: 10→0

Namely, the point value “P” was converted into the number “T” of remaining free games to be executed, at the timing when the number “T” of remaining free games to be executed had reached 0 in the game illustrated in FIG. 1A. Namely, the changes of the number “T” of remaining free games to be executed and the point value “P” indicate the fact that an execution time period of the bonus game has been extended by the point value. Further, the point value of 1 point corresponds to the single free game.

Next, with reference to FIG. 1C, the third stage will be described.

As illustrated in FIG. 1C, under the player's-high-hand display section 90 and the player's-low-hand display section 91, there are provided a banker's-high-hand display section 96 and a banker's-low-hand display section 97.

In the game after the player divides the cards for the mini game into two sets of cards, banker's seven cards are determined at first, and out of the seven cards, five cards forming the high hand and two cards forming the low hand are determined. The cards of the high hand and the cards of the low hand determined here correspond to banker's cards according the present invention. The determined cards of the high hand and the low hand are displayed to the banker's-high-hand display section 96 and to the banker's-low-hand display section 97 respectively. Thereafter, according to the method described in the rule of Pai-Gow poker, the player's high hand is compared with the banker's high hand and the player's low hand is compared with the banker's low hand to determine winning or losing in Pai-Gow poker. Then, based on the determined result of Pai-Gow poker and the five cards forming the player's high hand, the point value to be offered to the player in this mini game is determined. After the point value is determined, this determined point value is added to the point value displayed to the cumulative point value display section 99.

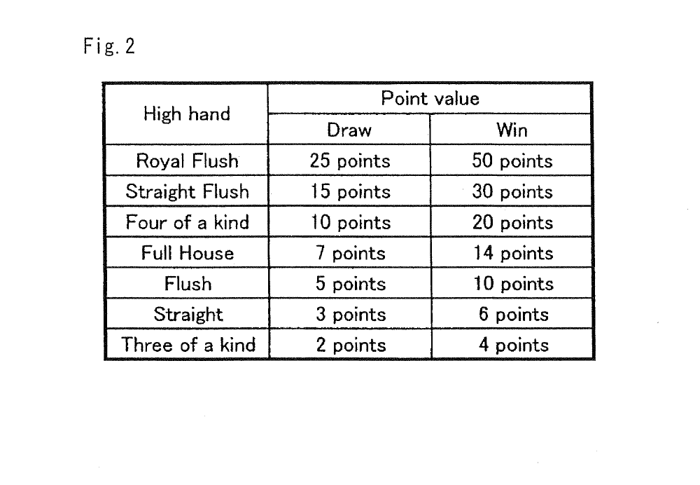

Here, with reference to FIG. 2, the method for determining the point value will be described.

FIG. 2 is a view illustrating the correspondence between the player's high hand and the point value.

As illustrated in FIG. 2, the point value to be offered to the player in the mini game is determined based on the player's high hand. There are defined point values according to the types of player's high hands, and different values are defined for a case where Pai-Gow poker results in a draw and for a case where Pai-Gow poker results in winning of the player. The point value to be offered to the player in a case where Pai-Gow poker results in winning of the player is set to be twice the point value to be offered to him or her in a case where Pai-Gow poker results in a draw. As described above, the point value to be offered to the player in the mini game is determined based on the player's high hand and the result of Pai-Gow poker. The player's high hand and the result of Pai-Gow poker correspond to the result of the mini game according to the present invention.

In the example illustrated in FIG. 1C, the player's high hand establishes Three of a kind. Further, the player's high hand is stronger than the banker's high hand and also the player's low hand is stronger than the banker's low hand, therefore, the player wins in Pai-Gow poker. Accordingly, the point value to be offered to the player in this mini game is 4 points. The point value displayed to the cumulative point value display section 99 has been changed to 4 points from 0 point in FIG. 1C compared to FIG. 1B.

As described above, in the present embodiment, a reference point value is preliminarily defined according to the player's high hand, and the value resulted from multiplication of the reference point value by a predetermined rate is offered to the player as the point value in this mini game, according to the result of Pai-Gow poker. In the present invention, it is possible to employ this method as a method for calculating the point value to be offered in the mini game. However, in the present invention, the method for calculating the point value to be offered in the mini game is not limited to this example. For example, the point value to be offered in the mini game maybe determined based on five cards selected by the player, out of the seven cards forming the combination of the player's cards, instead of the five cards forming the player's high hand.

In the example, the point value to be offered in the mini game is calculated based on a hand of player's cards. However, in the present invention, the point value to be offered in the mini game may be calculated based on the result of the mini game only. Further, in the example, the point value to be offered in the mini game is not calculated based on the number of BETs. However, in the present invention, the point value to be offered in the mini game may be calculated based on the number of BETs. For example, it is possible to set the point value to be offered in the mini game to be a value proportional to the number of BETs.

Also, in the present invention, it may be configured to indirectly generate a state where the point value to be offered is increased with the increase of the number of BETs, instead of calculating the point value directly based on the number of BETs. For example, it is possible to employ a configuration capable of increasing the probability of displaying the playing card having the same rank as the card for the mini game, with the increase of the number of BETs.

There has been described the Pai-Gow poker which is executed as the mini game on the slot machine 10. Next, there will be described the slot machine game which is executed as the main game.

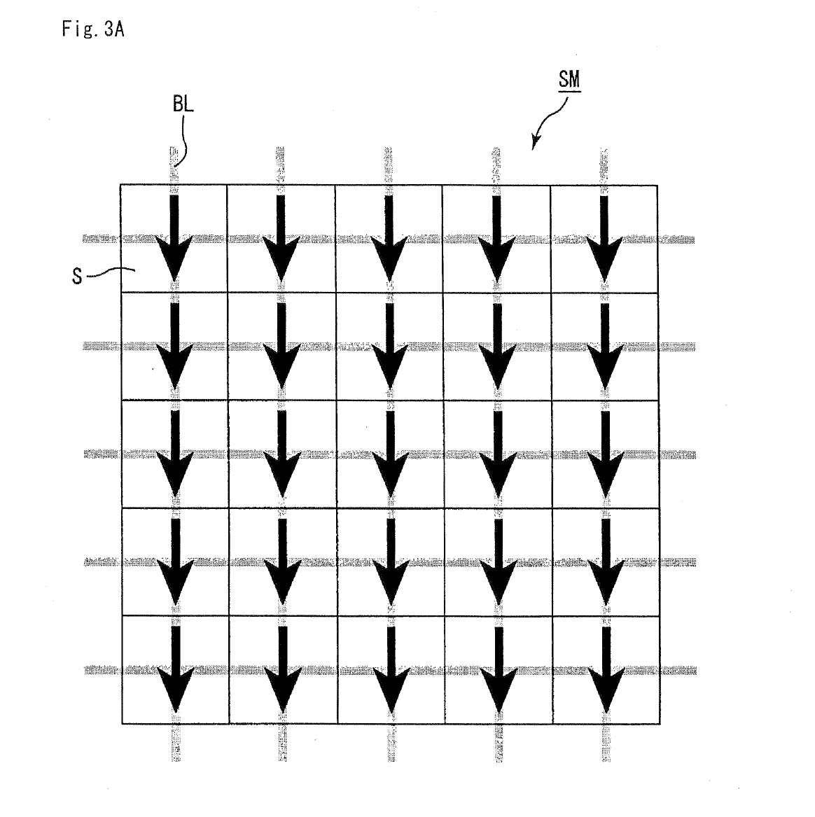

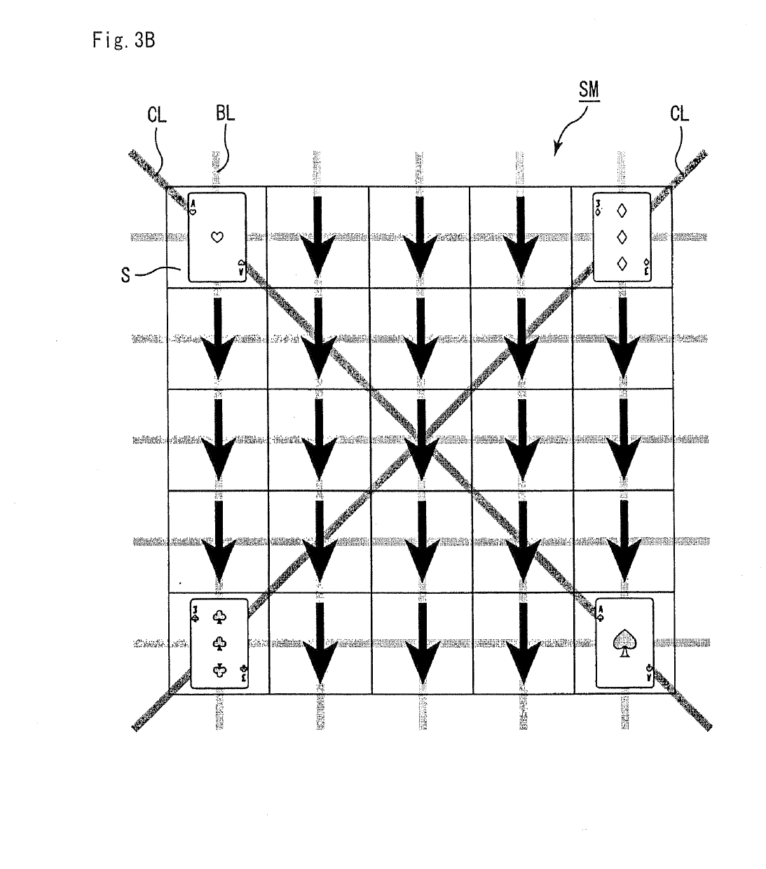

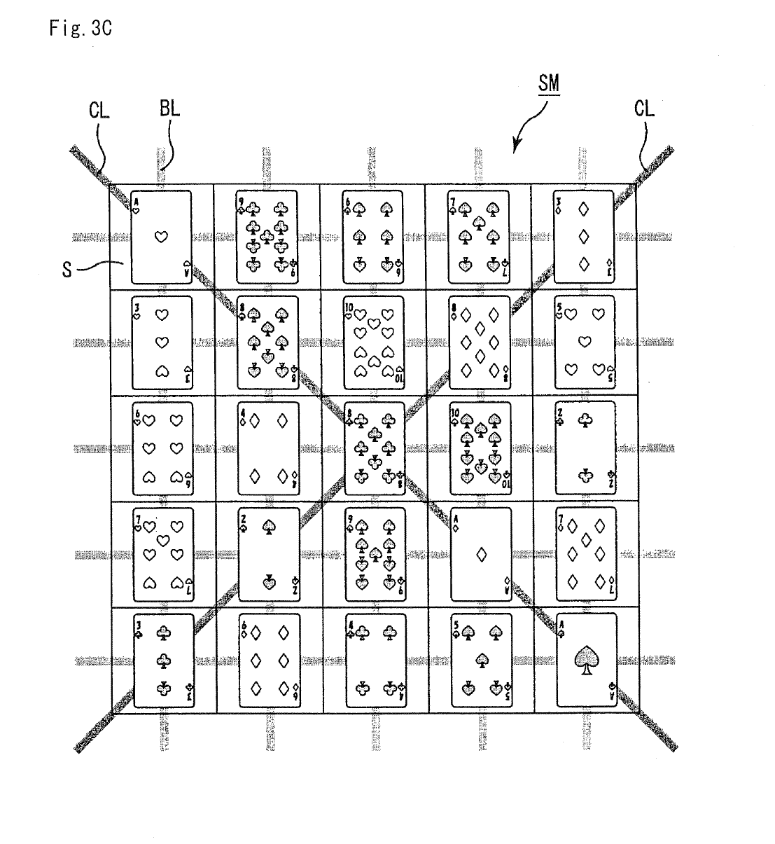

FIGS. 3A, 3B, and 3C are views illustrating an exemplary symbol matrix.

As illustrated in FIGS. 1A, 1B, and 1C, the symbol matrix SM 100 is displayed to the lower image display panel 16 included in the slot machine 10. The symbol matrix SM 100 is comprised of a total of 25 symbols in five columns and five rows. As illustrated in FIGS. 3A, 3B, and 3C, in the symbol matrix SM 100, ten basic lines BL are set along the respective columns and the respective rows. Further, in the present specification, the basic lines refer to winning lines other than cross lines. Further, there are set two cross lines CL obliquely across the symbol matrix SM 100.

As previously described, in the present embodiment, the playing card is used as the symbol. Depending on the combination of symbols established along the winning line, a payout value is determined. In the present embodiment, a poker combination is employed as the combination of symbols.

Royal Flush is a jack pot trigger. When five symbols which form Royal Flush are arranged along the winning line, a payout is conducted based on a progressive jackpot. Since the slot machine 10 is a standalone type slot machine, as the payout based on the progressive jackpot, the sum of an integrated value (a value resulted from integration of a part of the number of inserted game media) in the single slot machine 10 and an initial payout value is employed.

However, in the present invention, the integrated value used in the case of the progressive jackpot is not limited thereto. For example, in a case where the slot machine is connected to a network, the integrated value may be an integrated value in the same type of slot machines in a single casino, an integrated value in the same type of slot machines in the same area (for example, state or country), or the like.

Further, in the present embodiment, the payout based on the progressive jackpot is conducted in preference to the payout based on other symbols or the bonus game. Accordingly, for example, when both the jackpot trigger and a bonus game trigger are established at the same time, the payout based on the progressive jackpot is conducted, while no bonus game is executed.

Straight Flush is the bonus game trigger. When five symbols which form Straight Flush are arranged along the winning line, then the free game is executed for a predetermined number of times (10 free games, in the present embodiment). The free games are executed regarding that the coins in the same number at the time of generation of the free game have been inserted, even though no coins have been inserted.

The number of coin-outs per single inserted coin is respectively defined for Four of a kind, Full House, Flush, Straight, Three of a kind, and Two Pair. As the respective numbers of coin-outs, different numbers are defined for a case where the symbols are arranged along the basic line and a case where the symbols are arranged along the cross line. The number of coin-outs set for the case where symbols are arranged along the cross line is 1.5 times the number of coin-outs set for the case where the symbols are arranged along the basic line.

When the game is started, the basic lines BL are set as illustrated in FIG. 3A, and all the symbols within the symbol matrix SM 100 start to be scrolled. In the figure, downward arrows indicate symbols being scrolled. Then, symbols are rearranged at the four corners of the symbol matrix SM 100. At this time, in a case where the symbols placed at each diagonal pair of symbol matrix SM 100 are the symbols indicating cards having the same ranks, a cross line CL is set. For example, when the ranks of the cards displayed as a pair of symbols are “A” while the ranks of the cards displayed as another pair of symbols are “3” as illustrated in FIG. 3B, the two cross lines CL are set along the respective diagonal lines, in the symbol matrix SM 100.

Thereafter, the rest of the symbols in the symbol matrix SM 100 are rearranged.

At this time, when a predetermined poker combination as described above is established along the winning line, the payout is offered.

The payout is determined according to the following formula (1).

Payout=the number of coin-outs corresponding to the poker combination×the number of coin-ins (1)

While, in the present embodiment, the display area is a symbol matrix, in the present invention, symbols are not necessarily required to be arranged in a matrix shape in the display area. Also, the display area may have a polygonal shape with N angles (N is a natural number equal to or greater than 4). In this case, cross lines are set for the respective pairs of the opposite corners of the polygonal shape with N angles.

While, in the present embodiment, there has been described a symbol matrix comprised of a total of 25 symbols in five columns and five rows, the number of symbols is not particularly limited, in a case where the display area is a symbol matrix. It is possible to properly change the shapes, the types, the number, and the like of symbols as required. In this case, the combination relating to the payout may be properly set as required, according to the shape, the type, the number and the like of symbols.

In the present embodiment, there has been described a case where the same number of basic lines are set regardless of the number of BETs and, also, the payout, when a predetermined poker combination is established, is determined based on the number of coin-outs determined for respective poker combinations and the number of BETs. However, the present invention is not limited to this case. For example, the number of basic lines may be varied according to the number of BETs, or the payout, when the predetermined poker combination is established, may be constant regardless of the number of BETs.

While, in the present embodiment, there has been described a case where the number of coin-outs in the event of the establishment of the predetermined poker combination along the cross line is 1.5 times the number of coin-outs in the case of the establishment of the same poker combination along the basic line, the present invention is not limited to the case.

While, in the above-described example, the cross line is set in addition to the basic line, in the present invention, no cross line may be set.

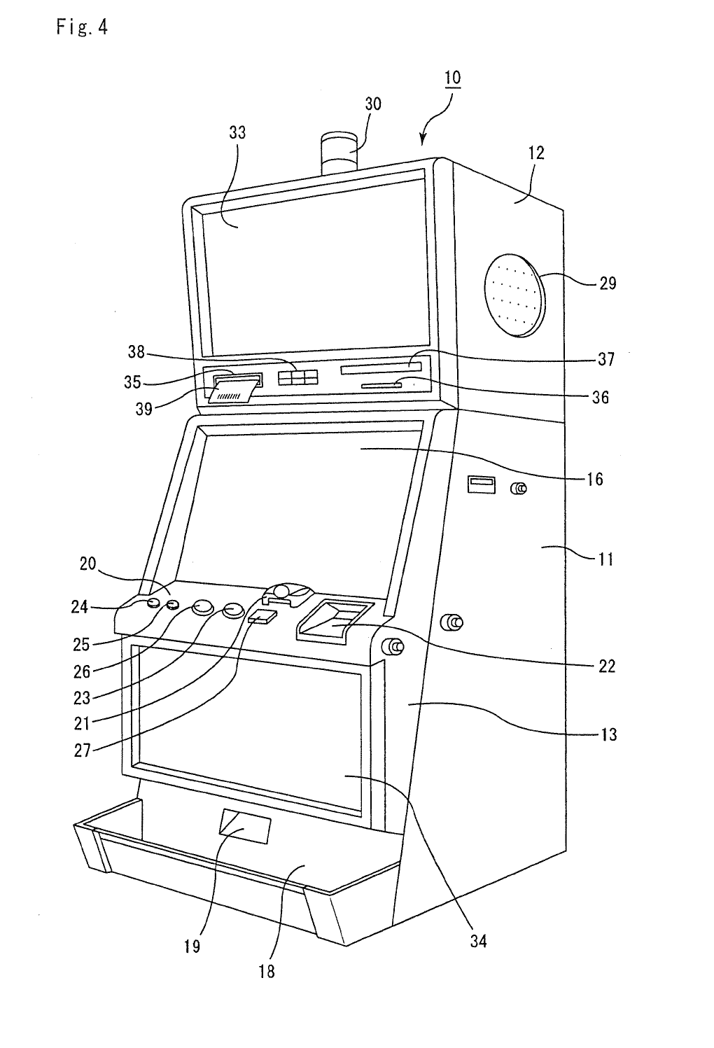

FIG. 4 is a perspective view schematically illustrating a slot machine according to one embodiment of the present invention.

The slot machine 10 includes: a cabinet 11; a top box 12 installed on the upper side of the cabinet 11; and a main door 13 provided at the front face of the cabinet 11. The lower image display panel 16 is provided at the front side of the main door 13. The lower image display panel 16 is provided with a liquid crystal display panel to which there is displayed a symbol matrix SM 100 (see FIGS. 1A to 1C, 3A to 3C) comprised of a total of 5×5=25 symbols. In the lower image display panel 16, there are provided a number-of-credits display section 31 and a number-of-payouts display section 32 (not shown in the figure) To the number-of-credits display section 31, an image indicating the number of credited coins is displayed. To the number-of-payouts display section 32, an image indicating the number of coins to be paid out as the payout is displayed.

Further, a touch panel 69, which is not shown in the figure, is provided at the front face of the lower image display panel 16. The player can input a variety of commands by operating the touch panel 69.

Below the lower image display panel 16, there are provided: a control panel 20 comprised of a plurality of buttons 23 to 27 with each of which a command associated with game progress is input by the player; a coin receiving slot 21 through which a coin is accepted into the cabinet 11; and a bill validator 22.

The control panel 20 is provided with: a start button 23; a change button 24; a CASHOUT button 25; a 1-BET button 26; and a maximum BET button 27. The start button 23 is used for inputting a command to start the game. The change button 24 is used for making a request of a staff in the recreation facility to exchange. The CASHOUT button 25 is used for inputting a command to pay out credited coins to a coin tray 18.

The 1-BET button 26 is used for inputting a command to bet one coin, out of the credited coins, on the game. The maximum BET button 27 is used for inputting a command to bet the maximum number of coins that can be bet on one game (fifty coins in the present embodiment), out of the credited coins, on the game.

The bill validator 22 not only discriminate a regular bill from a false bill, but also accepts the regular bill into the cabinet 11. Further, the Bill validator 22 may be configured to be capable of reading a later-described ticket 39 with a barcode. A belly glass 34 on which a character or the like of the slot machine 10 is drawn is provided at the lower front of the main door 13, namely, below the control panel 20.

On a front surface of the top box 12, an upper image display panel 33 is provided. The upper image display panel 33 is provided with a liquid crystal display panel to display, for example, an image representing introduction of the contents of the game and explanation of a rule of the game.

A speaker 29 is provided in the top box 12. A ticket printer 35, a card reader 36, a data display device 37, and a key pad 38 are provided under the upper image display panel 33. The ticket printer 35 prints on a ticket a barcode as coded data of the number of credits, a date, identification number of the slot machine 10, and the like, and outputs the ticket 39 with a barcode. The player can have another slot machine read the ticket 39 with a barcode to play a game thereon, or exchange the ticket with a barcode with a bill and the like at a predetermined place in the recreation facility (for example, a cashier in a casino).

The card reader 36 reads data from a smart card and writes data into the smart card. The smart card is a card to be carried by a player, and stores, for example, data to identify the player and data on the history of the game played by the player. Data corresponding to the coin, the bill, or the credit may also be stored in the smart card. Also, in place of the smart card, a magnetic stripe card may be employed. The data display device 37 is comprised of a fluorescent display and the like, and displays, for example, data read through the card reader 36 or data input by the player through the key pad 38. The key pad 38 is used for inputting a command and data to issue a ticket and the like.

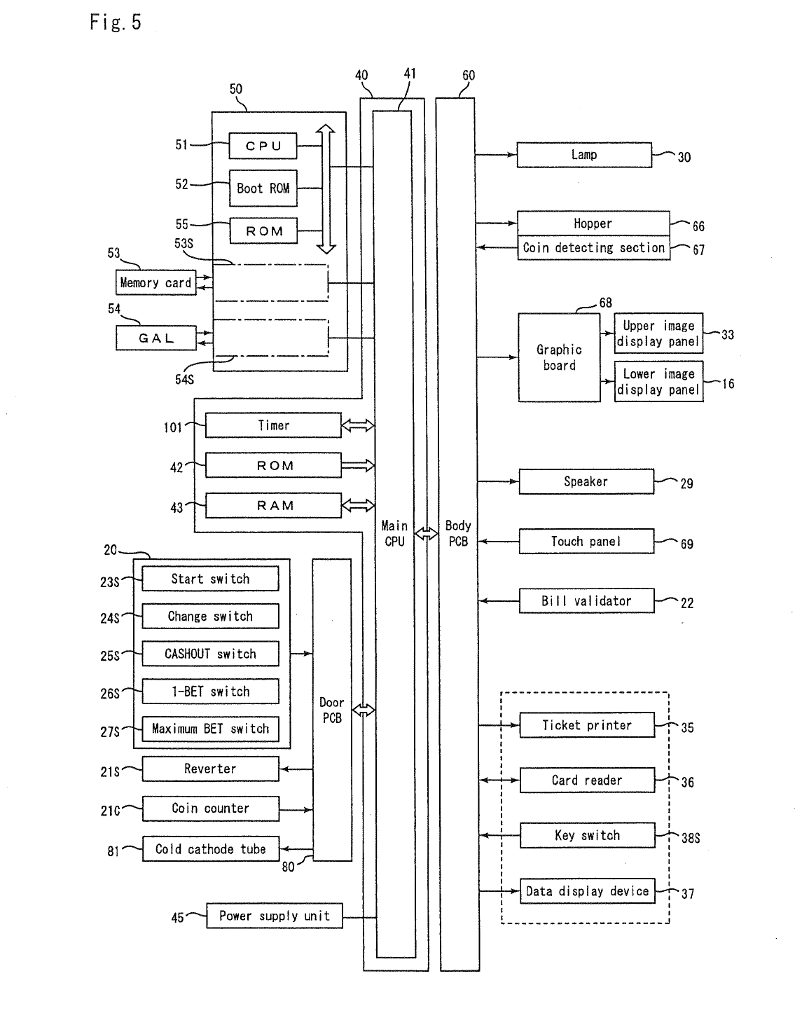

FIG. 5 is a block diagram illustrating the internal structure of the slot machine illustrated in FIG. 4.

A gaming board 50 is provided with: a CPU (Central Processing Unit) 51, a ROM 55, and a boot ROM 52 which are interconnected to one another by an internal bus; a card slot 53S corresponding to a memory card 53; and an IC socket 54S corresponding to a GAL (Generic Array Logic) 54.

The memory card 53 is comprised of a nonvolatile memory such as CompactFlash (registered trademark), and stores a game program and a game system program. The game program includes a symbol selection program. The above-mentioned symbol selection program is a program for determining a symbol to be rearranged in a symbol matrix. The above-mentioned symbol selection program includes symbol weighing data respectively corresponding to a plurality of types of payout ratios (for example, 80%, 84%, 88%). The symbol weighing data is data indicating the correspondence between respective symbols and one or a plurality of random numbers belonging to a predetermined numerical range (0 to 255). The payout ratio is set based on payout-ratio setting data output from the GAL 54, and based on the symbol weighing data corresponding to this payout ratio, the symbol to be rearranged in the symbol matrix are determined. Further, the game program includes table data (see FIG. 2) indicating the correspondence between symbols and the payout value.

Further, the card slot 53S is configured to allow the memory card 53 to be inserted thereinto or ejected therefrom and is connected to a mother board 40 through an IDE bus. Accordingly, the types and contents of games played in the slot machine 10 can be changed by ejecting the memory card 53 from the card slot 53S, then writing another game program and another game system program into the memory card 53 and then inserting the memory card 53 into the card slot 53S. The game program includes a program relating to progression of the game. Further, the game program includes image data and sound data to be output during game. This image data includes image data and the like indicating a symbol matrix.

The GAL 54 is a type of PLD having a fixed OR array structure. The GAL 54 includes a plurality of input ports and a plurality of output ports, and when predetermined data is input to an input port, the GAL 54 outputs data corresponding to this data from an output port. The data output from this output port is the above-described payout-ratio setting data.

Further, the IC socket 54S is configured such that the GAL 54 can be mounted thereonto and removed therefrom, and is connected to the mother board 40 through a PCI bus. Accordingly, the GAL 54 can be replaced with another GAL 54 to change the payout-ratio setting data.

The CPU 51, the ROM 55 and the boot ROM 52 interconnected to one another by the internal bus are connected to the mother board 40 though the PCI bus.

The mother board 40 is configured using a commercially available general-purpose mother board (a print wiring board on which fundamental components of a personal computer are mounted), and comprises: a main CPU 41; a ROM (Read Only Memory) 42; a RAM (Random Access Memory) 43; and a timer 101. The mother board 40 corresponds to the controller.

The ROM 42 is comprised of a memory device such as a flash memory, and stores a program such as BIOS (Basic Input/Output System) executed by the main CPU 41 and permanent data. When the BIOS is executed by the main CPU 41, processing for initializing a predetermined peripheral devices is conducted, concurrently with start of processing for loading the game program and game system program stored in the memory card 53 via the gaming board 50. In the present invention, ROM 42 may or may not be rewritable one.

The RAM 43 stores data and a program used at the time of operation of the main CPU 41. Further, the RAM 43 is capable of storing the game program. Moreover, the RAM 43 stores data on the number of credits, the number of coin-ins or coin-outs in one game, and the like. Further, the timer 101 conducts time measurement.

Both a later-described body PCB (Printed Circuit Board) 60 and a door PCB 80 are connected to the mother board 40 through USBs. A power supply unit 45 is also connected to the mother board 40.

The body PCB 60 and the door PCB 80 are connected with an equipment and a device, which generate an input signal to be input into the main CPU 41, and an equipment and a device, operations of which are controlled by a control signal output from the main CPU 41. The main CPU 41 executes the game program stored in the RAM 43 based on the input signal input into the main CPU 41, and thereby conducts the predetermined arithmetic processing and stores the result thereof into the RAM 43, or transmits a control signal to each equipment and device as processing for controlling each equipment and device.

The body PCB 60 is connected with a lamp 30, a hopper 66, a coin detecting section 67, a graphic board 68, a speaker 29, a touch panel 69, a bill validator 22, a ticket printer 35, a card reader 36, a key switch 38S, and a data display device 37. The lamp 30 is lighted in a predetermined pattern based on a control signal output from the main CPU 41.

The hopper 66 is installed inside the cabinet 11, and pays out a predetermined number of coins from a coin payout exit 19 onto a coin tray 18, based on a control signal output from the main CPU 41. The coin detecting section 67 is provided inside the coin payout exit 19, and in the case of detecting the payout of the predetermined number of coins from the coin payout exit 19, outputs an input signal to the main CPU 41.

The graphic board 68 controls, based on the control signal output from the main CPU 41, image display to the upper image display panel 33 and the lower image display panel 16. The number of credits stored in the RAM 43 is displayed to the number-of-credits display section 31 (not shown in the figure) of the lower image display panel 16. The number of coin-outs is displayed to the number-of-payouts display section 31 (not shown in the figure) of the lower image display panel 16. The graphic board 68 comprises a VDP (Video Display Processor) for generating image data based on the control signal output from the main CPU 41 and a video RAM for temporarily storing image data generated by the VDP, and the like. Further, image data used in generating the image data by the VDP is included in the game program, which is read from the memory card 53 and stored in RAM 43.

The bill validator 22 not only discriminates a regular bill from a false bill, but also accepts the regular bill into the cabinet 11. The bill validator 22, when accepting the regular bill, outputs an input signal to the main CPU 41 based on a face amount of the bill. The main CPU 41 stores in the RAM 43 the number of credits corresponding to the amount of the bill transmitted by the input signal.

The ticket printer 35, based on the control signal output from the main CPU 41, prints on a ticket a barcode formed by encoding data such as the number of credits, a date, an identification number of the slot machine 10, and the like, and outputs the ticket as the ticket 39 with a barcode.

The card reader 36 transmits to the main CPU 41 data read from the smart card and writes data into the smart card based on the control signal from the main CPU 41. The key switch 38S is provided on the key pad 38, and when the key pad 38 is operated by a player, outputs a predetermined input signal to the main CPU 41. The data display device 37 displays, based on a control signal output from the main CPU 41, data read by the card reader 36 and data input by the player through the key pad 38.

The door PCB 80 is connected with the control panel 20, a reverter 21S, a coin counter 21C and a cold cathode tube 81. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. When the buttons 23 to 27 are operated by the player, each of the switches 23S to 27S corresponding thereto outputs input signals to the main CPU 41.

The coin counter 21C is provided inside the coin receiving slot 21, and discriminates a regular coin from a false coin inserted into the coin receiving slot by the player. Coins other than the regular coin are discharged from the coin payout exit 19. The coin counter 21C, on detecting the regular coin, outputs an input signal to the main CPU 41.

The reverter 21S operates based on the control signal output from the main CPU 41, and distributes the coin recognized by the coin counter 21C as the regular coin into a cash box (not shown in the figure) or the hopper 66, which are disposed in the slot machine 10. Namely, when the hopper 66 is filled with coins, the regular coin is distributed by the reverter 21S into the cash box. On the other hand, when the hopper 66 is not filled with coins, the regular coin is distributed into the hopper 66. The cold cathode tube 81 functions as a back light installed on the rear face sides of the lower image display panel 16 and the upper image display panel 33, and is lighted based on the control signal output from the main CPU 41.

Next, there will be described processing conducted in the slot machine 10.

The main CPU 41 reads and executes the game program to progress the game.

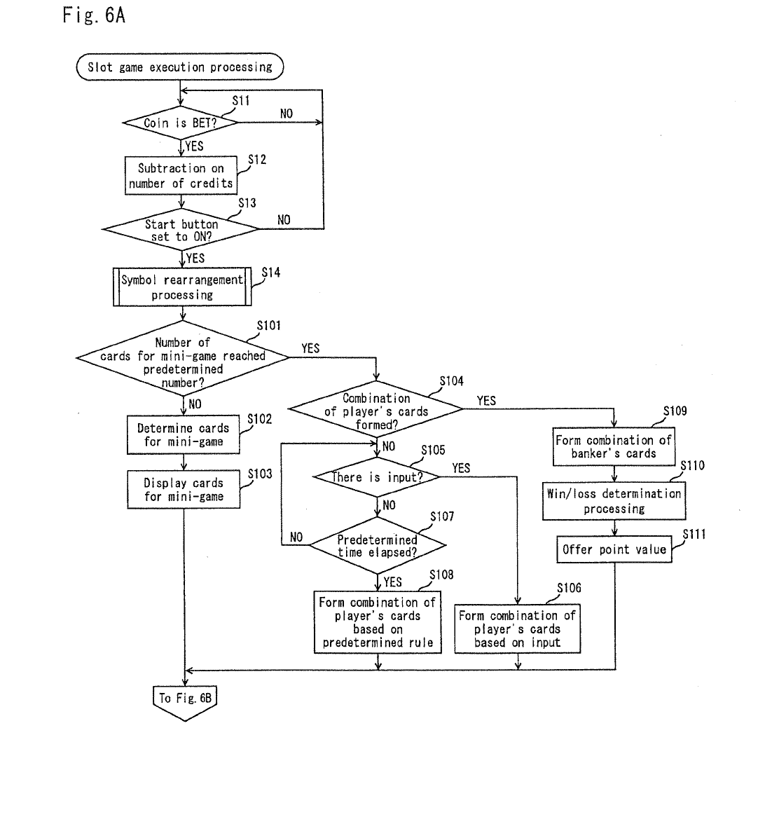

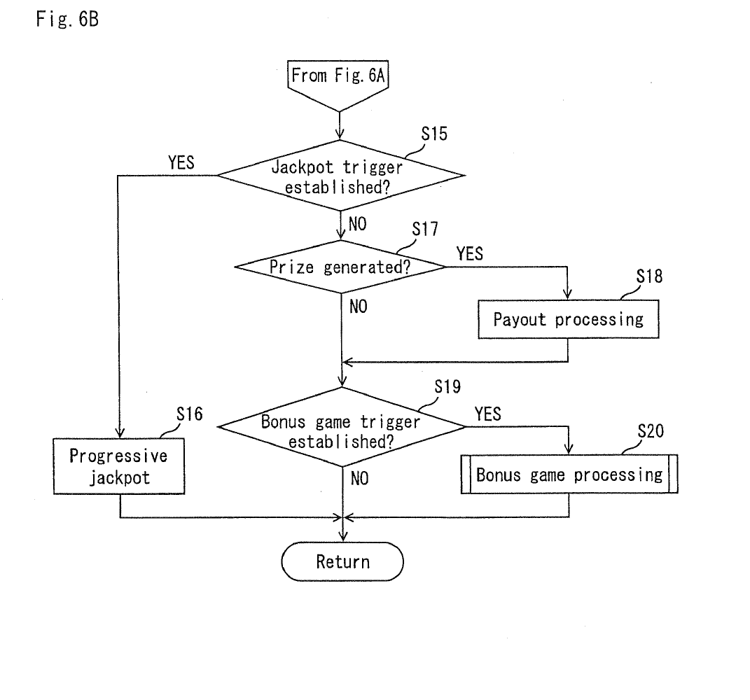

FIGS. 6A and 6B are flowcharts showing a subroutine of a slot game execution processing.

The slot game includes the slot machine game and the mini game. In the slot game execution processing, the main CPU 41 at first determines whether or not the coin is BET (step S11) In the processing, the main CPU 41 determines whether or not to have received an input signal output from the 1-BET switch 26S when the 1-BET button 26 is operated or an input signal output from the maximum BET switch 27S when the maximum BET button 27 is operated. When determining that the coin is not BET, the main CPU 41 returns the processing to step S11.

On the other hand, when determining in step S11 that the coin is BET, the main CPU 41 conducts processing for performing a subtraction on the number of credits stored in the RAM 43 according to the number of BET coins (step S12). In a case where the number of BET coins is larger than the number of credits stored in the RAM 43, the main CPU 41 returns the processing to step S11 without conducting a processing for performing a subtraction on the number of credits stored in the RAM 43. Further, in a case where the number of BET coins exceeds the upper limit (50 coins in the present embodiment) up to which a BET is possible in one game, the main CPU 41 shifts the processing to step S12 without conducting the processing for performing a subtraction on the number of credits stored in RAM 43. Further, the main CPU 41 cumulatively accumulates, in the RAM 43, a part of the subtracted number of credits (for example, a predetermined ratio) as an integrated value for a progressive jackpot.

Then, the main CPU 41 determines whether or not the start button 23 is set to ON (step S13). In this processing, the main CPU 41 determines, whether or not to have received an input signal output from the start switch 23S when the start button 23 is pressed.

When determining that the start button 23 is not set to ON, the main CPU 41 returns the processing to step S11. Further, in a case where the start button 23 is not set to ON (for example, in a case where a command to terminate the game is input without setting the start button 23 ON), the main CPU 41 cancels the result of the subtraction in step S12.

On the other hand, when determining in step S13 that the start button 23 is set to ON, the main CPU 41 conducts symbol rearrangement processing (step S14).

Here, the symbol rearrangement processing will be described.

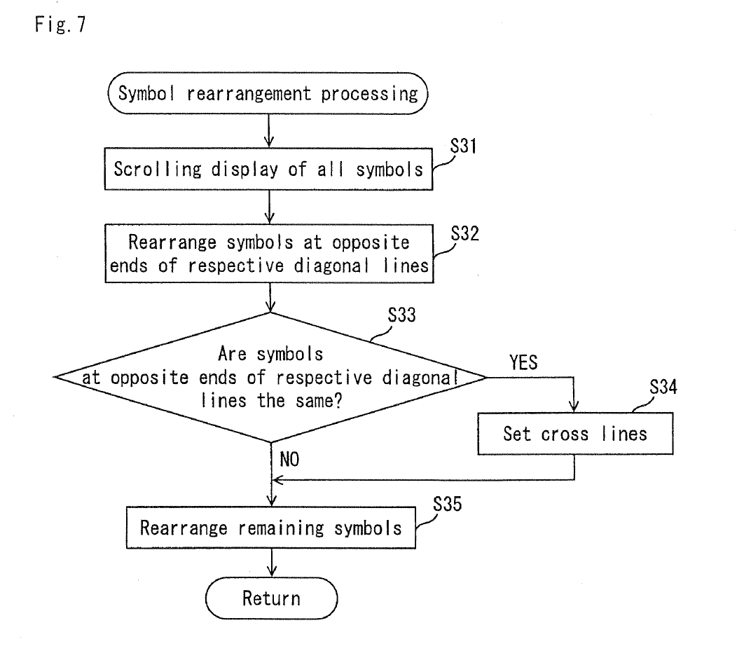

FIG. 7 is a flow chart illustrating a subroutine of the symbol rearrangement processing.

First, the main CPU 41 starts scrolling display of all symbols included in the symbol matrix SM 100, to the lower image display panel 16, as illustrated in FIG. 3A (step S31). At this time, 10 basic lines are set within the symbol matrix SM 100, regardless of the number of BETs.

Next, as illustrated in FIG. 3B, the main CPU 41 rearranges symbols at opposite ends of the respective diagonal lines of the symbol matrix SM 100 (step S32). In this processing, the main CPU 41 executes the above described symbol selection program to determine the types of the four symbols to be rearranged at opposite ends of the respective diagonal lines. Further, in determining the symbols to be rearranged, it may be configured such that the symbols to be rearranged at opposite ends of the respective diagonal lines are determined first, and then the remaining symbols are determined. Also, it may be configured such that all the symbols are determined first, then symbols are rearranged at the opposite ends of the respective diagonal lines, and thereafter, symbols that are yet to be arranged are rearranged.

Next, the main CPU 41 determines whether or not the ranks of the cards displayed as the symbols at the opposite ends of the respective diagonal lines are the same (step S33). In a case where the ranks of the cards displayed as the symbols at opposite ends of the respective diagonal lines are the same, the two cross lines CL along the respective diagonal lines are set (step S34). When determining that in step S33 that the ranks of the cards displayed as the symbols at opposite ends of the respective diagonal lines are not same or when conducting the processing in step S34, the main CPU 41 rearranges symbols, which are yet to be arranged, included in the symbol matrix SM 100 (step S35). Thereafter, the main CPU 41 ends the present subroutine and returns the processing to the subroutine of FIG. 6A.

Next, the main CPU 41 determines whether or not the number of cards for the mini game has reached a predetermined number. More specifically, the main CPU 41 determines whether or not the number of cards for the mini game being displayed to the mini-game card display section 93 is seven (step S101). When determining that the number of cards for the mini game is seven, the main CPU 41 shifts the processing to step S104. On the other hand, when determining that the number of cards for the mini game is not seven, the main CPU 41 shifts the processing to step S102.

In step S102, the main CPU 41 determines a single card as a card for the mini game. More specifically, the main CPU 41 selects a single symbol, out of the 25 symbols rearranged in the symbol matrix SM 100 in step S14, using random numbers, and determines a playing card having the same rank and the same suit as those of the playing card displayed as the selected symbol, as the card for the mini game.

Next, the main CPU 41 displays the single card for the mini game determined in step S102, to the mini-game card display section 93 (step S103).

After conducting the processing in step S103, the main CPU 41 shifts the processing to step S15.

The processing that the main CPU 41 conducts in steps S101 to S103 corresponds to the processing (b) according to the present invention.

While, in the present embodiment, Pai-Gow poker is executed as the mini game, the game executed as the mini game in the present invention is not limited to this example. Namely, the number of cards for use in the mini game is not particularly required to be seven, but the number of cards for use in the mini game may be properly set as required.

Further, in the present embodiment, a single card for each single mini game is successively displayed, and through seven games, seven cards for the mini game are displayed to the lower image display panel 16.

However, in the present invention, the number of cards for the mini game displayed in the single game is not limited to this example. For example, the number of cards for the mini game displayed in the single game may be a predetermined number equal to or more than two.

Also, the number of cards for the mini game displayed in the single game may be different in each game. Further, the card for the mini game is not particularly required to be displayed in every game, and there may be a game in which no card for the mini game is displayed. For example, it may be configured such that the cards in number which is required for the mini game may be displayed anytime, at random timing during the games in number equal to the number of cards for use in the mini game.

Further, the number of games required for displaying the cards for use in the mini game is not required to be equal to the number of cards required for the mini game. The number of games required for displaying the cards for use in the mini game may be either larger or smaller than the number of cards required for the mini game. For example, all the cards in number which is required for the mini game may be displayed in a single game.

Further, in the present embodiment, the following method is employed, as a method for determining the card for use in the mini game. Namely, playing cards are displayed as symbols, and a single symbol is selected out of the rearranged symbols, at random. Then, a playing card having the same rank and the same suit as those of the playing card displayed as the selected symbol, is displayed to the mini-game card display section 93.

In the present embodiment, the symbol which becomes the basis of the card for use in the mini game is determined at random. However, in the present invention, the symbol which becomes the basis of the card for use in the mini game may be selected by the player. In this case, the number of symbols as targets to be selected may be changed according to the number of BETs. For example, it is possible to employ a configuration as follows. When the number of BETs is equal to or larger than a predetermined number, the player can select the symbol which becomes the basis of the card for use in the mini game, out of a predetermined number of symbols placed at predetermined positions (for example, a total of 10 symbols which is the sum of five symbols in the rightmost row and five symbols in the leftmost row), out of 25 symbols. On the other hand, when the number of BETs is smaller than the predetermined number, the player can select the symbol which becomes the basis of the card for use in the mini game, only out of a smaller number of symbols (for example, five symbols in the rightmost row only) compared to the case when the number of BETs is equal to or more than the predetermined number.

While, in the present embodiment, playing cards are displayed with regard to all the symbols in the symbol matrix SM 100, it is not particularly required to display playing cards with regard to all the symbols in the symbol matrix SM 100, in the present invention. Playing cards may be displayed with regard to only a part of the symbols in the symbol matrix SM 100, and the card for the mini game may be determined based on the symbols indicating playing cards, out of the rearranged symbols.

Further, in the present invention, there may be employed a configuration which does not display the playing card as the symbol. For example, information about the rank and the suit of playing cards may be displayed in words, such as “Diamond and 6”. Also, pictures irrelevant to playing cards may be displayed as symbols, and these pictures may be associated with information about the ranks and the suits of playing cards. For example, it may be configured such that, using pictures indicating “SUN”, “HEART”, and the like as symbols, these pictures are preliminarily associated with information about the ranks and the suits of playing cards, in such a way that “SUN” is associated with “Spade and 8” and “HEART” is associated with “HEART and 10.”

Also, in the present invention, it is possible to employ a structure which displays playing cards along with symbols other than playing cards. For example, in the above case, along with a picture indicating “SUN” displayed as a single symbol, a playing card indicating “Spade and 8” may be displayed.

In the above described case, there is correspondence between the symbol and information about the playing card. Accordingly, in the case of employing the above configuration, similar to the present embodiment, it is possible to select a single symbol (or a plurality of symbols) out of the rearranged symbols and determine the card for the mini game based on the selected symbol.

While, in the above described example, there has been described a case where there is correspondence between the symbol and information about the playing card, in the present invention, the card for the mini game may be determined irrelevant to the symbols.

When determining in step S101 that the number of cards for the mini game is seven, the main CPU 41 determines whether or not a combination of player's cards has been formed (step S104). More specifically, the main CPU 41 determines whether or not the seven cards for the mini game have been divided into two sets of cards, as the high hand and the low hand. When determining that the cards for the mini game have been divided into two sets of cards, the main CPU 41 shifts the processing to step S109. On the other hand, when determining that the cards for the mini game have not been divided into two sets of cards, the main CPU 41 shifts the processing to step S105.

In step S105, the main CPU 41 determines whether or not an inputting operation for dividing the cards for the mini game into two sets of cards as the high hand and the low hand based on the signal received from the touch panel 69, has been completed. When determining that the inputting operation for dividing the cards for the mini game into two sets of cards as the high hand and the low hand has not been completed, the main CPU 41 shifts the processing to step S107. On the other hand, when determining that the inputting operation for dividing the cards for the mini game into two sets of cards as the high hand and the low hand has been completed, the main CPU 41 shifts the processing to step S106.

In step S106, the main CPU 41 clears the respective cards displayed to the mini-game card display section 93 and displays each of the cards to the player's-high-hand display section 90 or to the player's-low-hand display section 91 to form combinations of player's cards, based on the signal received from the touch panel 69. After conducting the processing in step S106, the main CPU 41 shifts the processing to step S15.

When determining in step S105 that the inputting operation for dividing the cards for the mini game into two sets of cards as the high hand and the low hand has not been completed (step S105: No), the main CPU 41 determines whether or not a predetermined time period has elapsed since the seven cards for the mini game were displayed to the mini-game card display section 93 (step S107). When determining that the predetermined time period has not elapsed, the main CPU 41 returns the processing to step S105.

On the other hand, when determining that the predetermined time period has elapsed, the main CPU 41 divides the cards for the mini game into two sets of cards to form combinations of player's cards, based on a predetermined rule (step S108). Here, the predetermined rule is the same rule as the rule (a predetermined house rule) based on which the main CPU 41 forms combinations of banker's cards in step S109, which will be described later.

After conducting the processing in step S108, the main CPU 41 shifts the processing to step S15.

The processing that the main CPU 41 conducts in steps S104 to S108 corresponds to the processing (c) according to the present invention.

While, in the present embodiment, Pai-Gow poker is executed as the mini game, the mini game according to the present invention is not limited to Pai-Gow poker, as previously described. Namely, in the mini game according to the present invention, it is possible to properly change the number of sets of player's cards which form combinations of player's cards and the numbers of cards in the respective sets of cards as required.

Further, in the present embodiment, combinations of player's cards are formed as follows. Namely, the player determines, one by one, whether to have the card displayed to the mini-game card display section 93 as the card of the high hand or the card of the low hand, to form combinations of player's cards, by operating the high-hand determination button 94 and the low-hand determination button 95. However, in the present invention, the method for forming combinations of player's cards is not limited to this example. For example, a plurality of candidate combinations of player's cards, out of cards for the mini game, may be displayed so that the player can select combinations of player's cards out of the displayed candidates.

Further, in the present embodiment, combinations of player's cards are formed based on the predetermined rule, not through the player's operation (hereinafter, referred to as “combinations of player's cards are automatically formed”), when the inputting operation for dividing cards for the mini game into two sets of cards as the high hand and the low hand has not been completed even after the elapse of a predetermined time period since the seven cards for the mini game were displayed to the mini-game card display section 93.

However, in the present invention, the starting point of measuring the predetermined time period relating to the condition to have combinations of player's cards be automatically formed is not limited to the timing when the seventh cards for the mini game is displayed to the mini-game card display section 93. For example, the starting point of measuring the predetermined time period relating to the condition to have combinations of player's cards be automatically formed may be the timing when the rearrangement of symbols is completed in the subsequent game to the game in which the seventh card for the mini game was displayed to the mini-game card display section 93.

Further, in the present embodiment, the method for forming combinations of player's cards in a case where the combinations are automatically formed is the same as the method for creating combinations of banker's cards (the above-mentioned predetermined rule). However, the method for forming the combinations in a case where combinations of player's cards are automatically formed may be either the same as the method for forming combinations of banker's cards or different therefrom. Also, in a case where combinations of player's cards are automatically formed, the combinations may be formed at random.

In the above example, there has been described a case where the mini game is the game in which cards for the mini game are divided into a plurality of sets of cards. However, the mini game according to the present invention is not limited to the game in which cards are divided into a plurality of sets of cards. For example, there may be employed a game as the mini game, in which the player makes a selection relating to the game according to cards dealt to him or her, such as Blackjack and Caribbean Stud Poker.

When determining in step S104 that the cards for the mini game have been divided into two sets of cards (step S104: Yes), the main CPU 41 forms combinations of banker's cards (step S109) More specifically, the main CPU 41 determines seven cards for the mini game using random numbers and determines the cards of the high hand and the cards of the low hand, out of the determined seven cards. Then, the main CPU 41 respectively displays the determined cards of the high hand and the cards of the low hand to the banker's-high-hand display section 96 and the banker's-low-hand display section 97.

Next, the main CPU 41 conducts processing for determining winning or losing of the game by comparing the combinations of player's cards formed in step S106 or S108 with the combinations of banker's cards formed in step S109, based on the strengths of the hands (step S110). More specifically, the main CPU 41 compares the player's high hand with the banker's high hand to determine which of them is stronger than the other, and also compares the player's low hand with the banker's low hand to determine which of them is stronger than the other, and determines winning or losing of the game based on the result of the determination. More specifically, when the player's high hand is stronger than the banker's high hand and the player's low hand is stronger than the banker's low hand, the game results in winning by the player. When the banker's high hand is stronger than the player's high hand and the banker's low hand is stronger than the player's low hand, the game results in winning by the banker. When one player's hand, out of high hand and low hand, is stronger than the banker's corresponding hand and the other banker's hand is stronger than the player's corresponding hand, the game results in a draw.

Next, the main CPU 41 conducts processing of offering a point value (step S111). More specifically, the main CPU 41 calculates the point value to be offered to the player in this mini game, based on the player's high hand and the result of winning or losing of the game determined in step S110 (see FIG. 2), and adds the calculated point value to the cumulative point value displayed to the cumulative-point-value display section 99.

After conducting the processing in step S111, the main CPU 41 shifts the processing to step S15.

The processing that the main CPU 41 conducts in steps S109 to S111 corresponds to the processing (d) according to the present invention.

In the present embodiment, when combinations of banker's cards are formed, only the cards determined as cards of the high hand and the low hand are displayed, while the seven cards before being divided into the high hand and the low hand are not displayed. However, in the present invention, when combinations of banker's cards are formed, the cards before being divided into a plurality of sets of cards maybe displayed. In this case, the cards before being divided into a plurality of sets of cards may be displayed, and after the elapse of a certain time period since then, combinations of banker's cards may be displayed.

Further, in the present embodiment, combinations of banker's cards are formed in the subsequent game to the game in which combinations of player's cards are formed. However, in the present invention, combinations of banker's cards may be formed just after combinations of player's cards are formed, in the game in which combinations of player's cards are formed.

In the present embodiment, similarly to the processing in steps S101 to S103, the processing in steps S104 to S111 is conducted after the processing of rearranging symbols in step S14. However, the processing (c) and (d) according to the present invention may be conducted during rearrangement of symbols.

In step S15, the main CPU 41 determines whether or not the jackpot trigger has been established, namely whether or not Royal Flush has been established along the winning line. When determining that the jackpot trigger has been established, the main CPU 41 executes the progressive jackpot (step S16). The number of coin-outs based on the progressive jackpot corresponds to the value resulted from adding an initial payout value to the integrated value (a value resulted from integrating a part of the number of inserted game media) stored in the RAM 43, and the payout thereof is performed through hand-pay. In step S16, the processing conducted by the main CPU 41 includes, for example, outputting notification sound from the speaker 29, lighting the lamp 30, printing the ticket 39 with a barcode printed the barcode indicating the number of coin-outs thereon. Thereafter, the present subroutine is terminated.

On the other hand, when determining in step S15 that no jackpot trigger has been established, the main CPU 41 determines whether or not a prize has been generated (step S17). Here, the generation of the prize refers to the establishment of at least a single combination out of Four of a kind, Full House, Flush, Straight, Three of a kind, and Two Pair, along the winning line.

When determining that the prize has been generated, the main CPU 41 pays out coins according to the numbers of coin-outs determined for the respective poker combinations and the number of BETs (step S18). When the coins are to be accumulated, the main CPU 41 conducts processing for performing an addition on the number of credits stored in the RAM 43. On the other hand, when the coins are to be paid out, the main CPU 41 transmits the control signal to the hopper 66 to pay out a predetermined number of coins.

When determining in step S17 that no prize has been generated or when conducting the processing in step S18, the main CPU 41 determines whether or not the bonus game trigger has been established, namely whether or not Straight Flush has been established along the winning line (step S19). When determining that the bonus game trigger has been established, the main CPU 41 reads, from the RAM 43, a program for executing a predetermined number of free games as the bonus game and executes a bonus game processing (step S20). When determining in step S19 that no bonus game trigger has been established or when conducting the processing in step S20, the main CPU 41 ends the present subroutine.

Next, there will be described the bonus game processing.

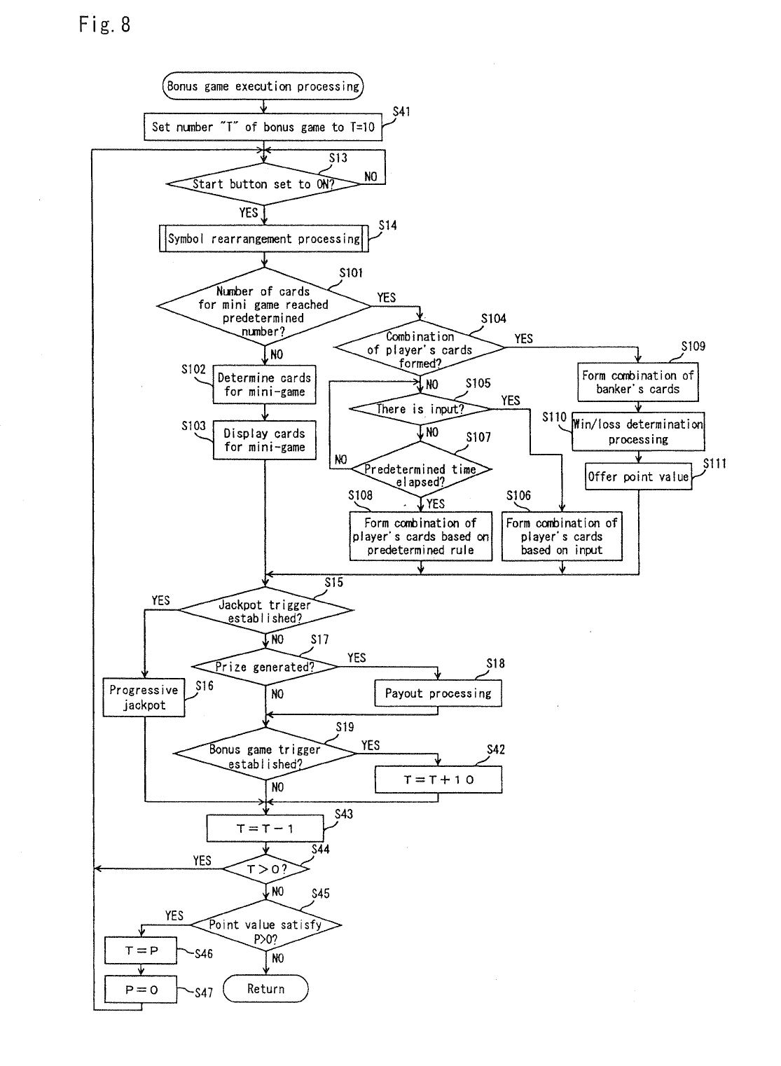

FIG. 8 is a flow chart illustrating a subroutine of the bonus game execution processing.

First, the main CPU 41 sets the number “T” of remaining free games to be executed as the bonus game to 10 (T=10) (step S41).

After conducting the processing in step S41, the main CPU 41 shifts the processing to step S13. The processing in steps S13 to S19 and the processing in steps S101 to S111 are as described with reference to FIGS. 6A and 6B and will not be repeated here. Hereinafter, the processing from step S42, which is conducted after step S19, will be described.

When determining in step S19 that the bonus game trigger has been established, the main CPU 41 sets the number “T” of remaining free games to be executed as the bonus game to T+10 (T=T+10) (step S42). Namely, the number of free games to be executed as the bonus game is increased by 10.

When determining in step S19 that no bonus game trigger has been established after conducting the processing in step S42, or when conducting the processing in step S16, the main CPU 41 sets the number “T” of remaining free games to be executed as the bonus game to T−1 (T=T−1) (step S43).

Next, the main CPU 41 determines whether or not the number “T” of remaining free games to be executed as the bonus game is larger than 0 (step S44). When determining that the value of “T” is larger than 0, the main CPU 41 returns the processing to step S13. On the other hand, when determining that the value of “T” is 0, the main CPU 41 shifts the processing to step S45.

In step S45, the main CPU 41 determines whether or not the point value “P” is larger than 0. When determining that the point value “P” is larger than 0, the main CPU 41 sets the number “T” of remaining free games to be executed as the bonus game to T=P (step S46). Then, the main CPU 41 sets the point value “P” to 0 (P=0) (step S47). After conducting the processing in step S47, the main CPU 41 returns the processing to step S13.

When determining in step S45 that the point value “P” is 0, the main CPU 41 ends the present subroutine.

In the present embodiment, the bonus game is executed by consuming the point value, only when Straight Flush is established along the winning line, and thereby generates the bonus game. Namely, unless Straight Flush is established along the winning line to generate the bonus game, the player can not play the bonus game by consuming the point value. However, in the present invention, the opportunity for the player to play the bonus game by consuming the point value is not limited to the case where game is shifted to the bonus game as the result of the rearrangement of symbols. For example, the gaming machine according to the present invention may be configured such that the player can input a command for executing the bonus game using the point value when the point value is accumulated and the input of the command cause the game to be shifted to the bonus game.

Although the embodiment according to the present invention is described, the description presents only some of the specific examples, and is not intended to limit the present invention in any way and specific constructions of each means and the like can be properly changed in terms of design. Besides, the effects described in the embodiment of the present invention are only the most preferable effects generated from the present invention and effects to be caused by the present invention is not limited to those described in the embodiment of the present invention.

There has thus been outlined, rather broadly, the more important features of the invention in order that the detailed description thereof aforementioned may be better understood, and in order that the present contribution to the art may be better appreciated. There are, of course, additional features of the invention that described above and which formed the subject matter of the claims appended hereto.

In this respect, above explaining at least one embodiment of the invention in detail, it is to be understood that the invention is not limited in its application to the details of construction and to the arrangements of the components set forth in the aforementioned description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

What is claimed as new and desired to be secured by Letters Patent of the United States is:

1. A gaming machine comprising:
a display capable of rearranging a plurality of symbols thereto;
an input device with which a player is capable of performing an operation relating to a game; and
a controller,
said controller programmed to conduct the processing of;
(a) executing a game in which said plurality of symbols are rearranged to said display and a gaming medium is paid out in number corresponding to the symbols rearranged or a combination thereof;
(b) displaying, in a time period during which at least a single game is executed, a predetermined number of cards for use in a mini game which is different from said game, to said display;
(c) determining cards for use in said mini game or a combination thereof, based on an input from said input device, in the game after said processing (b);
(d) determining, in the game after said processing (c) a result of said mini game based on the cards displayed in said processing (b) and the result of the determination in said processing (c), and offering a point value to the player based on this result; and
(e) executing a bonus game by consuming said point value, out of a normal game to be executed as said game and the bonus game which is more advantageous to the player than said normal game.

2. The gaming machine according to claim 1,
wherein
said processing (b) is a processing of
gradually adding cards to be displayed to said display, successively or intermittently during said plurality of games, until the number of cards displayed to said display reaches a predetermined number.

3. The gaming machine according to claim 1,
wherein
said symbols indicate cards for use in said mini game, and
said processing (b) is a processing of
selecting the symbol included in said plurality of symbols rearranged in said game and displaying the card indicated by the selected symbol to said display, successively or intermittently during said plurality of games, until the number of cards displayed to said display reaches a predetermined number.

4. The gaming machine according to claim 1,
wherein
said processing (c) is a processing of
dividing said predetermined number of cards into a plurality of sets of cards to form a plurality of combinations of player's cards, based on the input from said input device, in the game after said processing (b); and
said processing (d) is a processing of
determining the same number of cards as the number of cards displayed in said processing (b) and dividing the determined cards into a plurality of sets of cards to form a plurality of combinations of banker's cards, said plurality of combinations of banker's cards are same as said combinations of player's cards in the number of sets and the numbers of cards in the respective sets, and
comparing the plurality of combinations of player's cards with the plurality of combinations of banker's cards based on the strength of hands to determine the result of said mini game, and offering a point value to the player based on this result.

5. The gaming machine according to claim 4,
wherein
said processing (c) is a processing of
dividing said predetermined number of cards into a plurality of sets of cards, based on a predetermined rule, to form a plurality of combinations of player's cards, when there is no input from said input device for a predetermined time period since the number of said player's cards displayed to said display has reached the predetermined number.

6. A game controlling method comprising the steps of:
(a) executing a game in which a plurality of symbols are rearranged to a display and a gaming medium is paid out in number corresponding to the symbols rearranged or a combination thereof;
(b) displaying, in a time period during which at least a single game is executed, a predetermined number of cards for use in a mini game which is different from said game, to said display;
(c) determining cards for use in said mini game or a combination thereof, based on an input from an input device, in the game after said step (b);
(d) determining, in the game after said step (c), a result of said mini game based on the cards displayed in said step (b) and the result of the determination in said step (c), and offering a point value to the player based on this result; and
(e) executing a bonus game by consuming said point value, out of a normal game to be executed as said game and the bonus game which is more advantageous to the player than said normal game.
